(19) United States
(12) Patent Application Publication
(10) Pub. No.: US 2007/0100519 A1
(43) Pub. Date: May 3, 2007

(54) Diagnostic system

(75) Inventor: Michael Engel, Leonberg (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 10/558,081

(22) PCT Filed: Apr. 16, 2004
(86) PCT No.: PCT/EP04/04043

§ 371 Date: Oct. 4, 2006

(30) Foreign Application Priority Data
May 23, 2003 (DE) 103 23 384.9

(51) Int. Cl. G06F 19/00

(52) U.S. Cl. 701/33; 701/29; 340/438

(57) ABSTRACT

The invention relates to a diagnostic system, which uses a radio-based communications interface to download the results of the on-board system diagnosis in the vehicle and evaluates said results on an off-board diagnostic platform. The on-board diagnosis collects vehicle data by interrogating buses, to which the control units are connected, to identify errors. Said errors are processed and stored in a memory, together with relevant information concerning the condition of the control units. A diagnostic computer can retrieve said information at defined intervals and store it in a ring buffer. Once the telediagnosis has been initiated, the most significant data is sent to the diagnostic center at the customer assistance center (CAC). The data is then evaluated in the CAC on a central diagnostic platform using a complex diagnostic program. With the aid of the diagnostic program, conclusions are drawn with regard to the cause of the error. If additional vehicle data is required, it can be subsequently requested. Once the subsequently requested data has been received, the diagnostic program resumes and the analysis result is improved. The subsequently received data is sent to the center. The subsequent request for data can occur as often as required and is based on a configuration file that can be freely supplied with data or modified, said file being evaluated whilst the telediagnosis is in progress. The analysis results of the diagnostic program are converted from the vehicle-specific data format used by the control units into an XML metaformat and are stored.

This present invention relates to a diagnostic system in which a diagnostic program runs on an off-board diagnostic platform. The diagnostic program accesses the control units of the technical system to be diagnosed via a radio-based communications interface. The control units have a certain inherent diagnostic capability. A first automatically generated diagnostic result can be expanded and completed via a user interface with the diagnostic platform in a demand-controlled procedure.

The technological background for the invention disclosed here is formed by German Patent Application DE 197 25 915 A1 and German Patent Application DE 41 06 717 C1. With these previously known diagnostic systems, malfunctioning of the control units in a motor vehicle can be detected. The malfunction of the individual control units is recorded here in data packets and communicated in a network. The diagnostic program analyzes the data words communicated and delineates the error sources responsible for the malfunction by means of a test algorithm that runs automatically. This is a so-called model-based diagnosis. A model-based diagnosis is characterized by a knowledge of the chain of effects of the individual control units in the overall technical system. These chains of effects contain all the error sources that might be considered the cause of the error for the malfunctions in question. On the basis of test steps based on the chain of effects, the chain of effects is checked out completely and the error in the overall system is delineated. An example of a computer-assisted error diagnosing device is described in German Patent DE 195 23 483 C2, which relates to a diagnostic program in which the chains of effects are established on the basis of a structure model and an effect model. The technical system to be diagnosed here is divided into subsystems and a knowledge base module is assigned to each subsystem. Finally, an error model containing the error correlations of the individual subsystems and taking them into account is generated from the knowledge base modules and the structure model. By analyzing the knowledge base modules and the structure model, the diagnostic program automatically determines which subsystems and which individual errors of a subsystem can contribute to the malfunction detected. The diagnostic program then determines a decision tree for the malfunction thus found and the errors responsible for the malfunction can be delineated using this decision tree.

The systems described above to a certain extent form the core, in technical jargon also referred to as the kernel of a diagnostic system. The diagnostic program operates here with error codes which are not necessarily understandable just as code to a service technician. Therefore, it was proposed in German Patent Application DE 197 25 915 A1 that the diagnostic results should be displayed on a display screen using a browser such as that used for Internet web pages. The status information of the technical system to be diagnosed is processed here and displayed using a so-called markup language. Known markup languages include, for example, HTML (Hyper Text Markup Language) or SGML (Standard Generalized Markup Language).

In the meantime, on the basis of this technological background, a document management system for diagnostic data has been introduced based on the XML standard (XML for Standard extended Markup Language). A brief description of this XML document management system for diagnostic data can be found in the press notice from Software AG from Darmstadt of Oct. 10, 2002: “Workflow-supported XML document management for diagnostic data in development, production and service.” In this document management system, various types of documents can be stored for each control unit on a server and linked in a version-secure manner to a marker for the vehicle version or the control unit version on the basis of the XML standard. Examples of the various types of documents for each control unit in a motor vehicle include control unit specifications, test results and supplementary text information as well as graphs and images. The document management system here offers the possibility for the user himself to define access to certain control units and to certain documents as so-called fast access.

In accordance with the preceding discussion, the present invention is based on a diagnostic system for a motor vehicle such as that disclosed in European Patent Application EP 10 87 343 A1. This European patent application describes a diagnostic process in which remote diagnosis or telediagnosis of a vehicle is performed using an expert system by means of a radio-based communication interface, the diagnostic bus of the vehicle to be diagnosed is accessed from a diagnostic platform. The error codes of the individual control units are read out over the communications interface and are analyzed and evaluated by the expert system. The data transmission from the vehicle to the expert system takes place here preferably via a mobile wireless connection by means of the so-called SMS standard (SMS for Short Message Standard). After a connection has been established between the expert system and the vehicle, a vehicle identification is performed first and then the data memories of the various control units are read out and the data contents are transferred to the expert system. If no additional data is requested from the vehicle by the expert system, the connection is automatically terminated.

The disadvantages of the remote diagnostic system mentioned above include, among other things, the fact that all data is always being read out of the control units. In particular, the data contents to be transmitted in these previously known diagnostic systems are by no means selected with regard to relevance for defective vehicle states and transmitted separately. If previously known remote diagnostic systems having the data material to be transmitted do not arrive at an unambiguous diagnostic result or arrive at no diagnostic result at all, the diagnosis has failed. With the systems known in the past, there has been no possibility for intervening in the diagnostic process and optionally requesting specific data subsequently.

The object of the present invention is therefore to arrive at an improved diagnostic result with the least possible communication complexity.

This object is achieved with a diagnostic system or a diagnostic method, each having the features of the respective independent claims. Advantageous embodiments of the present invention can be found in the subclaims and in the description.

The solution to this problem is achieved mainly with a diagnostic system which is able to download the results of the on-board system diagnosis in the vehicle itself by means of a radio-based communications interface and to analyze the results on an off-board diagnostic platform. It is then possible to intervene in the diagnostic sequence via an operator interface in a Customer Assistance Center and expand the diagnostic result as needed. The on-board system diagnosis collects vehicle data for interrogating the buses, to which the control units are connected, about errors. These errors are processed and stored in a memory with relevant state information about the control units. A diagnostic computer in the vehicle or a bus master can retrieve this information at defined intervals and store it in a ring buffer. After triggering the telediagnosis, the most relevant data is packed into an SMS and sent to the central diagnostic office of the Customer Assistance Center (SMS for Short Message Standard in mobile wireless). The data analysis is then performed in the Customer Assistance Center on a central diagnostic platform using a complex diagnostic program. The diagnostic program here is essentially a complex software algorithm. Using this diagnostic program, conclusions regarding the cause of the error can be drawn. If additional vehicle data is also needed, this can be requested subsequently. Subsequent data requests can be performed either manually by a technician in the Customer Assistance Center or triggered automatically by the diagnostic program itself. Using the subsequently requested data, the diagnostic program is continued and the analytical results are improved. The subsequent data request is based on a complex method which analyzes the data already obtained. The data requested subsequently is packed into one or more SMSs and sent to the central office. The subsequent data request may be made as often as necessary. The subsequent data request is based on a freely configurable data file which can be provided with a basic data set as needed and is analyzed during the run time of the telediagnosis. The analytical results of the diagnostic program are converted from the vehicle-specific data format used by the control units to an XML metaformat and stored.

In a refinement of the present invention, the diagnostic system has a central thesaurus in the central diagnostic platform. Using the central thesaurus, the data and the analytical results of the diagnostic program can be processed for a web browser and displayed in various regional or national languages.

In an advantageous embodiment of the present invention, the diagnostic system or the diagnostic method includes a data completion unit. The data completion unit analyzes the initial data packet transmitted by SMS and supplements the transmitted data as needed with model-specific information about the technical system or vehicle to be analyzed by automatically re-requesting the additional relevant data for the errors that have occurred from the system to be analyzed.

In an alternative embodiment of the present invention, the data exchange between the vehicle and the central diagnostic platform takes place via an intermediate fleet server, e.g., a fleet board server. Fleet board servers are used mainly in commercial truck management in shipping and logistics companies for controlling and maintaining the fleet of vehicles. These fleet board servers therefore contain additional information about maintenance intervals for the vehicles, location of the vehicles, repairs performed, pending inspections, etc. Therefore, when fleet board servers are used, it is advantageous to include this information in the diagnostic result to obtain an improved diagnostic result. In this way, it is also possible to filter out inspections that will soon be due and to process them together with the errors that have occurred in the current situation. In this way, time spent by a vehicle in the shop of the shipping company can be reduced.

Mainly the following advantages are achieved with the present invention:

The solutions to the problem described above attempt to minimize data communication between the vehicle and the central office. This reduces the probability of loss of data packets in the transmission process or receiving the data packets too late for the central diagnostic program to run properly in the event of a network overload. In addition, not only pure state data but also information about defective components in the vehicle (e.g., lamp, seat, fuel injector, etc.) as well as error codes of the control units are transmitted. The subsequent request for data offers the possibility of subsequently requesting current data from the vehicle after interaction with the customer and therefore improving the analytical result.

Another advantage is that an employee in the customer assistance center can always inquire about the current status of the vehicle in a diagnostic sequence and can have the results displayed on a telediagnosis viewer. This makes it possible for a current diagnostic result to always be generated and for the driver of the vehicle to always be advised by up-to-date instructions in handling. These handling instructions may, for example, consist of the advice to take the vehicle to the nearest repair shop, or for less serious defects, to continue driving for the time being and have the problem corrected as soon as possible.

Another advantage of the telediagnostic system consists of the fact that it relies on central diagnostic platforms that are already in use and on-board diagnostic systems that are already installed in the vehicle. Therefore, the basic data set of the telediagnostic system can be provided by using diagnostic programs and diagnostic systems that are already available.

Due to the use of thesauruses, the diagnostic results that are generated can be displayed in various national languages. This is advantageous in that a technician in the Customer Assistance Center can select his native language to perform the diagnosis and the result of the diagnosis can be translated into the native language of the driver of the vehicle and transmitted for display in the vehicle.

Not least of all the use of XML data structures offers the advantage that the diagnostic results are independent of the formats used in the off-board systems and the on-board systems, which often operate with error codes that are not at all transparent. Since web-based applications are also compatible with the XML data format, the diagnostic results generated in the Customer Assistance Center can be forwarded to each workshop connected to the Internet via Internet connections or Intranet connections and can then be seen by the service technician in the workshop. The diagnostic specialist in the Customer Assistance Center and the service technician in the workshop can in this way always have the same current information status in front of them and can obtain advice over a telephone line, if necessary.

Exemplary embodiments of the present invention are explained in greater detail below on the basis of figures, in which:

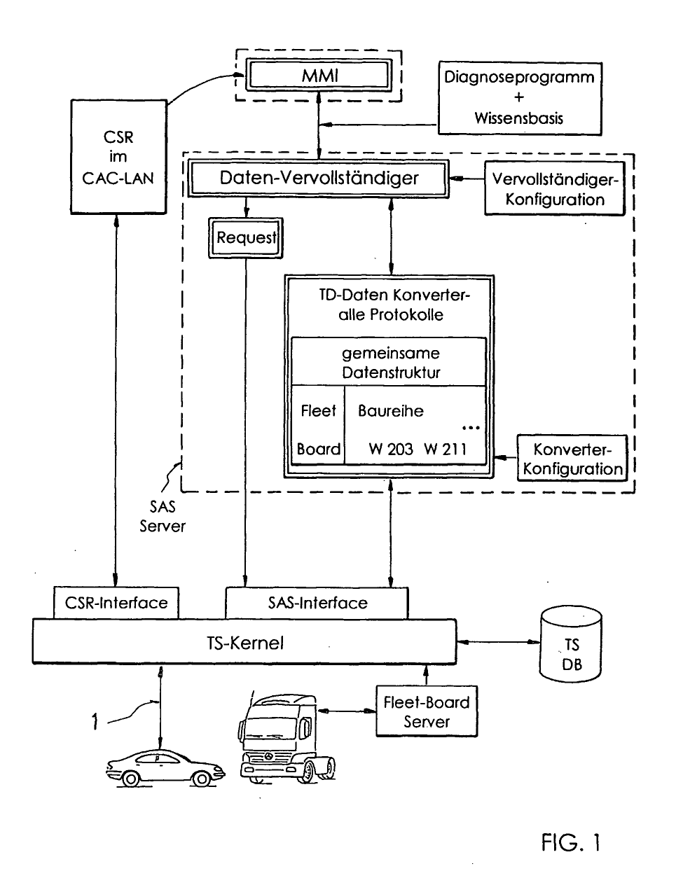

FIG. 1 shows a layer model for the telediagnostic system with the respective modules;

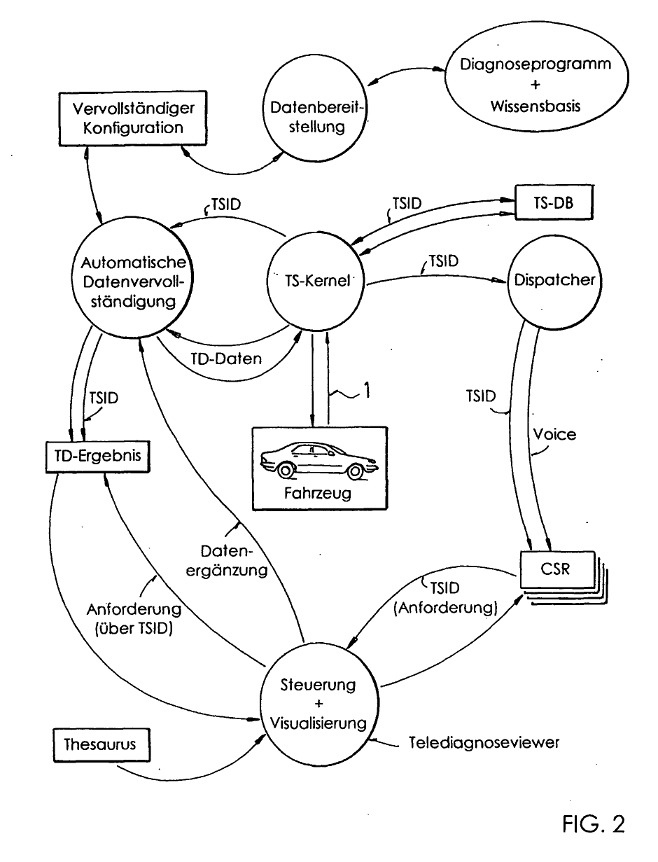

FIG. 2 shows a process overview of the telediagnostic system;

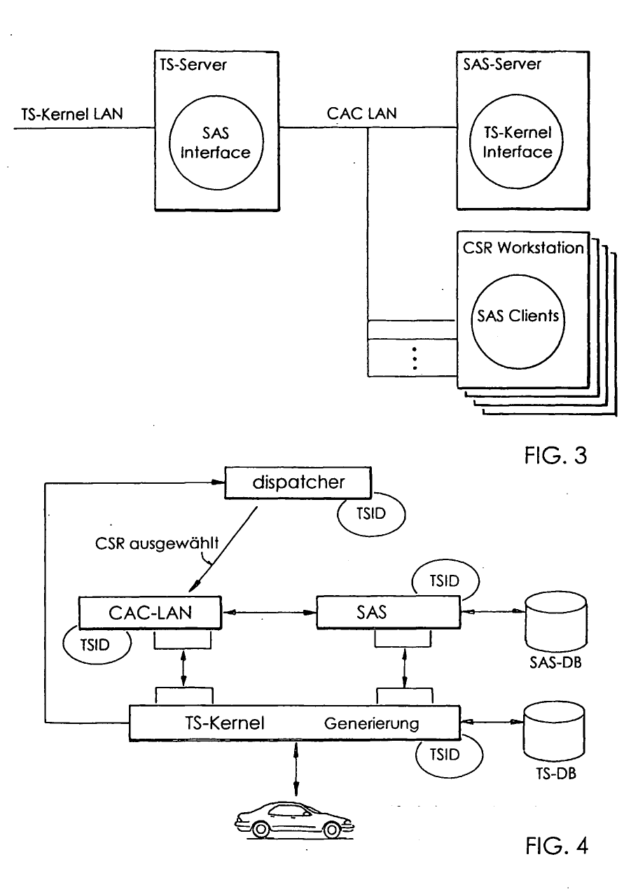

FIG. 3 shows a possible server structure for the telediagnostic system in the Customer Assistance Center;

FIG. 4 shows the connection of the application modules to the central diagnostic program;

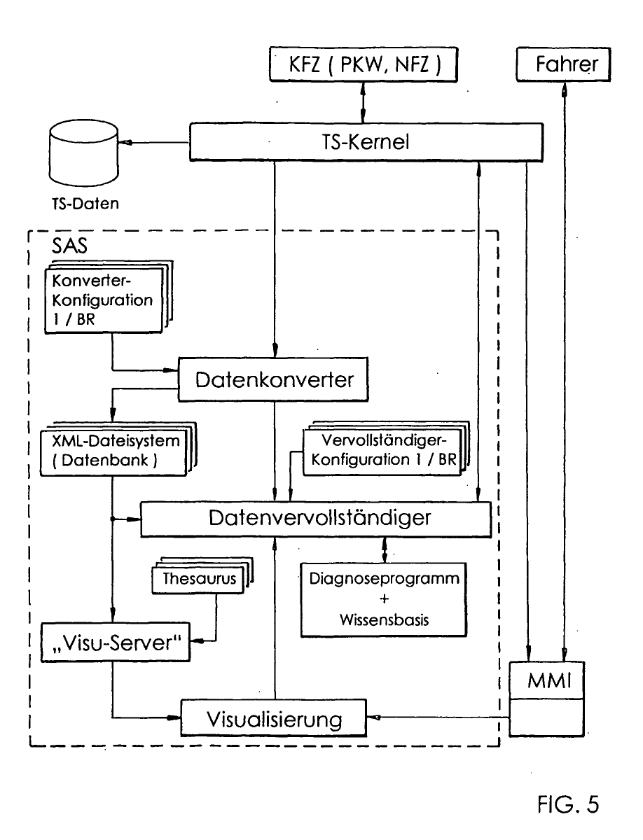

FIG. 5 shows a block diagram of a Service Assistant [sic; Assistance] Server;

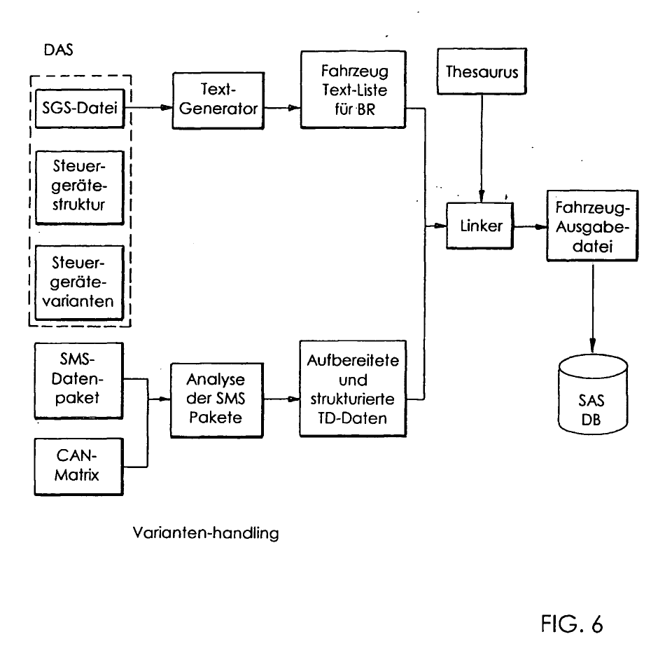

FIG. 6 shows an illustration of variant handling of various models;

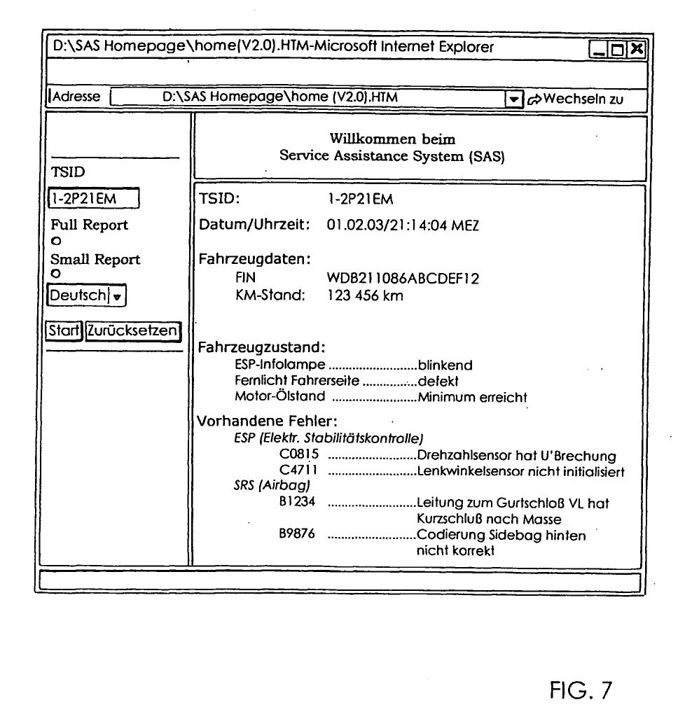

FIG. 7 shows a screen shot of the telediagnosis viewer in the Customer Assistance Center.

With reference to FIG. 1, the basic structure of the inventive telediagnostic system is described below. A telediagnostic system in the form of a data processing system is presented here for handling a vehicle breakdown incident at a call center, a so-called Customer Assistance Center, abbreviated CAC. This system can process and display telediagnostic data for various model series. At the customer assistance center, a diagnostic program is implemented on a central data processing platform. The diagnostic program has a connection to a central diagnostic database in which diagnosis-relevant information is stored; this includes information about the structure of the vehicles to be diagnosed, empirical information from the past and identifiers for identification of the vehicle and the control units in the vehicle itself. The diagnostic program has a communications interface with the servers in the Custom Assistant Center. The telediagnostic data is read into the diagnostic system at the input end via a radio-based communications interface 1. The radio-based communications interface is based on the essentially known standards for mobile wireless, in particular the formats of data transmission known as GSM and SMS (SMS for Short Message Service). To be able to receive the calls of incoming mobile wireless messages from various vehicles, the telediagnostic system has a central communications platform known as the Telematic Services Kernel (TS kernel) and a customer database TSDB. The communications platform performs a correction inquiry with the help of the customer database for incoming calls from the vehicles. This essentially checks on whether the inquiring vehicle is registered in the customer database TSDB. The vehicle identification number VIN is used for identification of the vehicle.

Another task of the central communications platform is to determine the current position of the vehicle with the help of GPS data transmitted by the mobile wireless connection. Therefore, digital highway maps and road maps are additionally stored in the customer database TSDB and used to determine the position of the vehicle. With the help of this information, the communications platform TS kernel determines the position of the vehicle and, if necessary, the service station nearest to the vehicle where the vehicle can be repaired.

The extent of the diagnostic data available that can be transmitted from the on-board system in the vehicle to the telediagnostic system in the Customer Assistance Center includes in particular the following data:
Status information about state values of the vehicle such as battery voltage, firing position, position data, kilometer reading, tank filling and the vehicle identification number (VIN). This data is transmitted as the initial data packet in a so-called initial TD message.
Additional information blocks which are transmitted only on request and pertain to, for example, basic data, power management data, status data, maintenance computer data, vehicle configuration data, status of services, status information diagnosis, components suspected of being defective, identification blocks of the control units, defective control units, control unit error codes, functions affected.

In contrast with the telediagnostic systems known previously, basic data is first sent from the vehicle to the telediagnostic system in the Customer Assistance Center with the initial data packet “Initial TD Message.” In an additional step, the additional information blocks mentioned above can be read out of the on-board system of the vehicle on request and as needed and transmitted from the vehicle to the telediagnostic system.

When the telediagnostic system is used for commercial vehicles and trucks, direct communication between the vehicle and the Customer Assistance Center is not preferred. Instead, data is exchanged via a centrally installed fleet board server, which is preferably used by the shipping and logistics company. Status and identification of the vehicle, position data, telephone number and language of the driver, date and time and information about the status of the vehicle including the control unit error codes are transmitted here. Access to the current maintenance data on the vehicle is also possible via the fleet board server.

For the communications link in the Customer Assistance Center, the communication platform TS kernel has two other interfaces. The TS kernel is connected to a so-called Service Assistant Server SAS server in the computer network of the call center via a server interface SAS interface. The TS kernel is connected to the computer network for the display workstations at the call center in the Customer Assistance Center Local Area Network CAC-LAN via a possible second interface, the CSR interface. The employees at the call center, the so-called customer service representatives CSR have the option of influencing the communications sequence in the TS kernel via the workstations with display screens in the Customer Assistance Center Local Area Network. In particular, they can subsequently request specific data via the CSR interface.

The diagnostic data transmitted is processed using the Service Assistant Server SAS server and displayed for the employees at the call center via a human-machine interface MMI in the form of a telediagnosis viewer. The Service Assistant Server in the call center includes mainly the following modules for data processing:
A data converter which converts the various data protocols that may be in use in various on-board networks of passenger vehicles and trucks into a uniform data format, in particular an XML structure, by means of a converter configuration.
A data completion unit which reads out of the vehicle to be diagnosed model-specific subsequent data requests per “request” to the SAS interface via the diagnostic program by means of a completion unit configuration. The data thus completed is displayed on the telediagnosis viewer MMI.

The data processing-supported systems for the Service Assistant Server for the actual diagnostic program and for the workstation computers in the local area network of the call center are based on the Windows NT4 operating system. The TCP/IP protocol is the standard as the data link between the systems. Suitable alternatives may also include a Unix/Linux-based system. The efficiency of the telediagnostic system takes into account here the realtime requirements of the diagnostic process to permit contact between the employee at the call center and a service technician in the workshop in realtime. This also includes the ability to diagnose multiple vehicles simultaneously.

FIG. 2 shows a process overview of the processes taking place on the Service Assistant Server SAS server. The central element for communication between the various processes here is an error case identification known as the Telematic Services Identifier (TSID), which is assigned by the central communications platform TS kernel to an incoming call from a vehicle. By means of this error case identification, the various subprocesses are synchronized and the results of the various subprocesses are unambiguously assigned to a pending current diagnostic process. First, the initial data packet incoming from the vehicle is subjected to an authorization check in the TS kernel. After a positive authorization check, the interface to the SAS server is initialized and the first initial data packet is analyzed in the SAS server and automatic data completion is performed on the basis of a logic unit.

This first processed diagnostic result is processed in text form using a thesaurus and is displayed on a telediagnosis viewer. The telediagnosis viewer serves to display the diagnostic results and is also used for further control if another diagnostic sequence is necessary. The automatic data completion is performed by means of a completion unit configuration, which is essentially a conversion table that records which model-specific data is to be additionally tied into the diagnostic process, taking into account the current vehicle status, i.e., which additional dynamic data (e.g., error codes of the control units) which might provide suggestions about the current error, should be requested. The model-specific data is represented by the data set provided. On the basis of the diagnostic results displayed and the error case identification TSID, the employees at the call center (CSR for Customer Service Representative) can retrieve additional information and control the remaining sequence of the diagnostic process in a targeted manner. In the entire diagnostic process, the incoming call together with the error case identification TSID is assigned by an automatic distributor (dispatcher) to an employee (CSR for Customer Service Representative) at the call center. By means of the error case identification TSID, the assignment of the incoming calls to employees at the call center can be made in a specific manner according to the qualifications of the employees. For example, an error in the engine control unit can be relayed in a targeted manner to a specialist in engine control units or an error in the antilock brake system can be forwarded in a targeted manner to the specialist for antilock brake systems.

FIG. 3 illustrates the minimum requirements of the network structure in the call center. Several data processing platforms CSR workstations are connected as SAS clients to the SAS server via a Customer Assistance Center Local Area Network CAC-LAN and also connected to the TS server. The SAS server is the above-mentioned Service Assistant Server while the TS server is the data processing platform for the diagnostic program. The TS server and the SAS server communicate via the SAS interface and/or via the TS kernel interface and with the SAS clients. Linking the SAS clients via a local area network offers the possibility of accessing the results of the telediagnosis compiled by the TS server and the SAS server from various workstation computers and displaying them on the workstation computers by means of a telediagnosis viewer.

FIG. 4 illustrates again how the Service Assistant Server SAS is tied into the telediagnostic system. Initialization of the telediagnosis process is triggered at the vehicle end by the driver of the vehicle or automatically by the on-board diagnostic system in the vehicle. If the telediagnosis process is triggered by the driver, this is done, for example, by operation of a special button in the vehicle which triggers the telediagnosis process. In the case of automatic triggering of the telediagnosis process by the on-board diagnostic system in the vehicle, the telediagnosis process is automatically triggered by the occurrence and detection of an error in the vehicle itself. By initializing the telediagnosis process, the on-board data in the control units of the vehicle and/or in the error memory of the on-board diagnostic system is updated and the data link to the TS kernel is established. An initial data packet consisting of a vehicle identification number VIN, a digital time stamp and digital error information is sent to the TS kernel via the communications interface. On the basis of the raw data from the vehicle and the entries in the customer database, the Telematic Services Data Base (TSDB), the TS kernel checks the access authorization to the telediagnostic system and stores the initial data packet in the form of a data object. This data object receives as an identifier an error case identification TSID. The incoming call from the vehicle triggers in the TS kernel a trigger mechanism for the telediagnostic system. After the incoming call, the interfaces from the TS kernel to the Customer Assistance Center Local Area Network CAC-LAN and the Service Assistant Server SAS are initialized and activated. In addition, the incoming call is assigned by a dispatcher to an employee CSR in the call center. The data flow is controlled here via the error case identifier TSID.

On the basis of FIG. 5, the operation of the data completion unit is described in greater detail below. An incoming call from the vehicle triggers a trigger mechanism for the Service Assistant Server SAS in the central communications platform TS kernel. At the same time, the initial data packet from the on-board diagnostic system in the vehicle is transferred from the TS kernel to the Service Assistant Server SAS. This data as well as all other telediagnosis data to be exchanged is converted into an XML data structure shared by all models of the vehicle, controlled by the configuration of the data converter. Then the converted data is interpreted by a logic unit implemented in the form of software in the data completion unit program module. In doing so, the data blocks capable of supplying additional information on error states are determined on the basis of the error states transmitted. These include, for example, service data, operating values, status of the on-board system diagnosis in the vehicle, controller units error codes, etc. These data packets thus obtained, retrieved from the vehicle and containing additional information on the error states, are automatically transmitted by the data completion unit to the TS kernel per request and from the TS kernel it is requested and read out of the vehicle via the communications interface. For example, the status of the on-board system diagnosis in the vehicle is requested, received, converted and interpreted. Per request, the diagnostic data, e.g., the error codes on the respective control unit, is requested and transmitted for each defective control unit in the vehicle. The incoming data is in turn converted and stored by the data converter module into the same XML structure for all models. In the converted form of the telediagnostic data, the bits and bytes of the raw data are replaced by the proper thesaurus indices representing a text description of the information. To display the data and the diagnostic results on the telediagnosis viewer, the thesaurus text messages are displayed via the thesaurus indices, which have already been assigned to the error codes thus obtained. The thesaurus text messages are generally understandable error text messages containing in particular the names of the diagnosed components. The employee at the call center can select the language in which the text is to be displayed by selecting a suitable thesaurus. Then the employee at the call center can have the diagnostic results displayed in English as the standard, for example, or can select his native language for display of the diagnostic results.

The data converter has the task of generating a vehicle-independent XML data structure from raw data. The conversion procedure for each model of a vehicle is obtained from a model-specific converter configuration. The data filename for the converted diagnostic result is generated automatically and is composed of the error case identifier TSID plus a digital time stamp. For example, ten fixed places in the data filename are reserved for the error case identifier TSID. After the error case identifier comes the time stamp, which includes information about the year, month, day and hours, minutes and seconds.

The data completion unit performs further processing of the XML data structure generated by the data converter. To do so, the data completion unit has a logic unit configured for each model via the completion unit configuration. The telediagnostic data in the XML data structure is analyzed with this logic. Necessary subsequent data requests for data sent to the vehicle are determined on the basis of the available data and the configuration. Depending on the choice of whether all the data or only the error-relevant data is to be retrieved and/or displayed, the requests to the vehicle as subsequent requests for data are formulated and transmitted via the TS kernel after analysis of the first initial data packet transmitted. The initial data packet contains basic vehicle information such as the vehicle identification number VIN, the time stamp, vehicle position data, voltage values from control units, the firing position of the ignition key and status messages of selected units and the status of warning lamps in the vehicle display. In addition, in a list transmitted with the initial data packet, the control units characterized as defective by the on-board diagnosis are marked. The data completion unit analyzes the data from the initial data packet after conversion to an XML data file by the data converter. The control units marked as defective in the initial data packet lead to a subsequent data request after analysis by the data completion unit. In this subsequent data request, additional data, e.g., the status block of the control unit and the error codes can be read out from the control unit marked as defective. If the diagnostic program on which the telediagnostic system is based is a model-based diagnostic program, other ambient data that can describe the error that has occurred in greater detail is also read out from the motor vehicle. This ambient data includes, for example, the status data on the neighboring control units in the hierarchy of the control unit diagnosed as defective. Alternatively, all vehicle data may also be requested. The subsequent data request is also transmitted over the radio-based communications interface, i.e., via mobile wireless, and preferably via the SMS standard here.

The analyzer logic for the subsequent data request is designed to be configurable here. This allows an adaptation of the data packets transmitted to model-specific particulars of each vehicle. The configuration is retained in an XML data file and is shown in FIG. 5 as a completion unit configuration. The information from the completion unit configuration is input again with each new call, thus ascertaining with which additional subsequent data request the telediagnostic system responds to the initial data packet received previously. The completion unit configuration is model-specific and can be adapted accordingly when there are changes in the vehicle model. If the diagnostic program does not arrive at a satisfactory diagnostic result with the data requested subsequently, then in addition to the automatically triggered subsequent request for data as already described here, there is also the possibility of a subsequent request for data by the employee at the call center. To do so, the previous diagnostic result is displayed on the telediagnosis viewer. The employee at the call center can then evaluate the previous diagnostic result. For any further subsequent manual request for data, the employee at the diagnostic center can request additional status data on the motor vehicle via the diagnostic program and have it read out. The employee at the call center also has the option of asking the driver of the vehicle by telephone connection about the error symptoms that have occurred in the vehicle.

On the basis of FIG. 6, the visualization of the diagnostic results on the telediagnosis viewer is discussed again in greater detail below. For visualization of the telediagnostic results, the data must first be linked to the corresponding thesaurus text via a process known as “incorporating the thesaurus.” A linker is responsible for linking the thesaurus. To do so, there are tables for interpretation of the data (error codes and other information) sent by the vehicle. This also includes control tables for identification of the control unit variants installed in the vehicle. The installed control unit variants usually vary from one model to the next. The installed control units are identified by the on-board diagnostic system, e.g., by means of the network addresses or other control unit data on the control units. These network addresses are preferably so-called CAN identifiers. Using a text generator, a model-specific and vehicle-specific text list containing the thesaurus indices relevant for this vehicle in the form of a data file is generated from the information on the control unit structure, the control unit variants and the error codes possible for the installed control units, said information having been generated from the information determined from stock data (SGS data file). The linker can then later connect the relevant respective thesaurus text in the various languages that can be selected for display in the telediagnostic system by using the thesaurus indices. The choice of which text is ultimately to be output will depend on the particular diagnostic data in each case. To do so, the incoming SMS data packets from the vehicle are analyzed and, as explained in conjunction with FIG. 5, a processed and structured diagnostic result is generated in the form of telediagnostic data. The error test relevant for this diagnostic result is selected on the basis of the error of the diagnostic result and the thesaurus indices referencing these error codes and this error text is tied into the diagnostic result. The structured diagnostic result generated in this way is either displayed or stored temporarily as a vehicle output data file on a memory medium of the Service Assistant Server.

Finally, FIG. 7 shows the diagnostic result generated with the telediagnostic system described above by using the telediagnostic method described above as visualized on the telediagnosis viewer. This shows the error case identifier TSID, the digital time stamp and basic vehicle information such as the vehicle identification number VIN and the kilometer reading of the vehicle. The vehicle status provides information about the errors that have occurred. In the exemplary embodiment shown here, it was found that the high-beam light on the driver's side was defective and the motor oil level had reached a minimum. Furthermore, a defect in the electronic stability program ESP was also found, and was displayed by a flashing ESP information light on the dashboard. Two possible error causes were identified by the telediagnostic system as the cause of the flashing ESP information light. These error causes are displayed with the error code and the thesaurus text assigned to this error code. Although the driver of the vehicle may be aware of a defect in the high-beam light or a malfunctioning electronic stability program, the driver cannot easily be aware of defects involving the airbag safety system, which were also detected by the telediagnosis. In the case of the airbags, two defects were found. First, the line to the left front belt lock had a short circuit, and secondly, at least one airbag in the rear of the vehicle was not correctly coded, i.e., the programming of the connected peripheral unit must be checked in the airbag control unit.

1. Diagnostic system for motor vehicles, comprising:
at least one off-board diagnostic platform with a diagnostic program and a respective knowledge base, which contains structure data of the systems to be diagnosed and a knowledge base of the system-specific error messages and their possible error causes,
with at least one radio-based communications interface for establishing a data link from the diagnostic platform to a communications interface in the vehicle which is in turn connected to control units in the vehicle,
whereby status information is read out of control units in the vehicle and an initial data packet is formed from this information, read out with the diagnostic program and used to calculate a first diagnostic result,
with at least one user interface of the diagnostic platform to a user computer network with at least one workstation having a display screen on which a telediagnosis viewer is installed,
characterized in that
the telediagnosis viewer is the operator interface to a server and the server expands the diagnostic result as needed by completing the diagnostic result with additional data.

2. Diagnostic system as claimed in claim 1, characterized in that the server contains a data converter which converts the initial data packet into an XML structure by means of a converter configuration and stores it as an XML data file.

3. Diagnostic system as claimed in claim 1, characterized in that the server contains a data completion unit which analyzes the initial data packet by means of a model-specific logic and reads out additional diagnostic information as needed by means of additional model-specific requests via the diagnostic program and the communications interface and performs the diagnosis.

4. Diagnostic system as claimed in claim 1, characterized in that the server contains at least one thesaurus.

5. Diagnostic system as claimed in claim 1, characterized in that a fleet server or another gateway to the vehicle data is contained therein.

6. Diagnostic system as claimed in claim 1, characterized in that the initial data packet contains a digital vehicle identification number, status information, an error summary, the vehicle position or a digital time stamp.

7. Diagnostic method for motor vehicles based on:
at least one off-board diagnostic platform with a diagnostic program and a respective knowledge base, which contains structure data of the systems to be diagnosed and a knowledge base of the system-specific error messages and their possible error causes,
with at least one radio-based communications interface for establishing a data link from the diagnostic platform to a communications interface in the vehicle, which is in turn connected to control units in the vehicle,
whereby status information is read out of control units in the vehicle and an initial data packet is formed from this information, read out with the diagnostic program and used to calculate a first diagnostic result,
with at least one user interface of the diagnostic platform to a user computer network having at least one workstation with a display screen on which a telediagnosis viewer is installed, whereby the telediagnosis viewer is the operator interface for the diagnostic method
characterized in that
in a first step on occurrence of a problem, a first short message containing a vehicle identification number and at least one error case identifier is sent to the diagnostic platform and a first diagnostic result is calculated in the form of an initial data packet,
and an additional status information is read out of control units in the vehicle in a demand-controlled process in a second step and the diagnostic result is completed with this information.

8. Diagnostic method as claimed in claim 7, characterized in that the initial data packet is converted to an XML structure by means of a data converter and a converter configuration and is stored as an XML data file.

9. Diagnostic method as claimed in claim 7, characterized in that the initial data packet is analyzed by means of a data completion unit which contains a model-specific logic and the diagnostic result is supplemented by means of model-specific additional requests.

10. Diagnostic method as claimed in claim 8, characterized in that the elements of the XML data file are linked to at least one thesaurus via indices and the text modules from the thesaurus are displayed on the telediagnosis viewer.

11. Diagnostic method as claimed in claim 10, characterized in that several selectable thesauruses in different languages are provided.

12. Diagnostic method as claimed in claim 7, characterized in that the initial data packet contains a digital vehicle identification number, status information, an error summary, the vehicle position or a digital time stamp.

13. Diagnostic method as claimed in claim 1, characterized in that the data link goes from the diagnostic platform to the vehicle via a fleet board server.

14. Man-machine interface for a diagnostic system for diagnosing a technical system having a knowledge base and a diagnostic program which provides a first diagnostic result in the form of an initial data packet comprising:
a data converter which converts the initial data packet into an XML structure on the basis of a converter configuration and stores it as a XML data file,
a data completion unit, which analyzes the data of the XML data file and reads out additional data from the technical system to be analyzed on the basis of the data of the initial data packet or, after sending a manual request and after conversion, saves this data to the XML data file by means of a completion unit configuration,
and a visualization of the XML elements stored in the XML data file in the form of an interactive user surface.

15. Diagnostic method as claimed in claim 8, characterized in that the initial data packet is analyzed by means of a data completion unit which contains a model-specific logic and the diagnostic result is supplemented by means of model-specific additional requests.

16. Diagnostic method as claimed in claim 9, characterized in that the elements of the XML data file are linked to at least one thesaurus via indices and the text modules from the thesaurus are displayed on the telediagnosis viewer.

17. Diagnostic system as claimed in claim 2, characterized in that the server contains a data completion unit which analyzes the initial data packet by means of a model-specific logic and reads out additional diagnostic information as needed by means of additional model-specific requests via the diagnostic program and the communications interface and performs the diagnosis.

18. Diagnostic system as claimed in claim 2, characterized in that the server contains at least one thesaurus.

19. Diagnostic method as claimed in claim 10, characterized in that the initial data packet contains a digital vehicle identification number, status information, an error summary, the vehicle position or a digital time stamp.

20. Diagnostic system as claimed in claim 2, characterized in that a fleet server or another gateway to the vehicle data is contained therein.
